(19) United States
(12) Patent Application Publication
(10) Pub. No.: US 2026/0171731 A1
(43) Pub. Date: Jun. 18, 2026

(54) Power strip with visual power monitoring

(71) Applicant: Honglin Electric Power Technology (Thailand) Co., Ltd., Rayong (TH)

(72) Inventors: Shengchao HU, Rayong (TH); Xiongbing LIU, Rayong (TH); Li YU, Rayong (TH)

(73) Assignee: Honglin Electric Power Technology (Thailand) Co., Ltd., Rayong (TH)

(21) Appl. No.: 18/985,822

(22) Filed: Dec. 18, 2024

(51) Int. Cl. H01R 13/717; H01R 25/00

(52) U.S. Cl. CPC H01R 13/7175; H01R 25/003

(57) ABSTRACT

The present invention a power strip with visual power monitoring, and relates to the technical field of sockets. The present invention includes a splitter and sockets, wherein the sockets are provided on the splitter, wherein a bus is electrically connected to the socket through the splitter, and the bus is connected to mains electricity; a power statistics module, the power statistics module is provided inside the splitter, wherein the power statistics module records the power of the sockets, and an indicating member, wherein the indicating member is provided on the splitter, and the power statistics module displays the power loaded by the sockets through the indicating member. In the present invention, when the power is on, all the sockets are in a power monitoring state.

### TECHNICAL FIELD

The present invention relates to the technical field of power strips, in particular to a power strip with visual power monitoring.

### BACKGROUND TECHNOLOGY

Power strips are also called power sockets and switch sockets. Power strips refer to sockets that can be plugged into one or more circuit wiring, through which various wiring can be inserted, thereby making it easy to connect with other circuits, and the connection and disconnection between lines and copper parts can ultimately achieve the connection and disconnection to the circuit. According to the purpose, power strips can be divided into civil power strips and industrial power strips.

The inventors found in their daily work that when a socket is overloaded, it is easy to cause a fire if it cannot be discovered in time. Therefore, if the real-time power of the sockets cannot be monitored when the sockets are in use, usage of the sockets cannot be identified in real time.

### SUMMARY OF THE INVENTION

The present invention is to solve the shortcomings of the prior art and to propose a power strip with visual power monitoring.

In order to achieve above purposes, the present invention adopts following technical proposals: a power strip with visual power monitoring, comprising a splitter, wherein, the power strip with visual power monitoring further comprises: sockets, wherein the sockets are provided on the splitter;

a bus, wherein the bus is electrically connected to the sockets through the splitter, and the bus is connected to mains electricity;

a power statistics module, wherein the power statistics module is provided inside the splitter, wherein the power statistics module records power of the sockets;

an indicating member, wherein the indicating member is provided on the splitter, and the power statistics module displays the power loaded by the sockets through the indicating member.

Preferably, the bus transfers the mains electricity to the sockets through a power distribution module inside the splitter, wherein the power distribution module comprises branch lines electrically connected to the sockets with end portions thereof electrically connected to the bus.

Preferably, the power statistics module respectively counts power on the branch lines and then summarizes into an internal adder, calculates results through the internal adder, calculates a ratio of calculated results to a set rated power, and lights up the indicating member according to calculated ratio.

Preferably, the indicating member comprises a plurality of grids of LED lights, and load power thereof from zero to a rated load corresponds to a zero grid to a full grid respectively.

Preferably, color of the LED lights gradually changes from green to red from a zero grid position to a full grid position.

Preferably, lamp beads are arranged on the splitter, and the lamp beads emit light when the splitter is powered on.

Compared with the prior art, the advantages and positive effects of the invention are as follows:

The present invention comprises safety sockets with real-time power monitoring technology and instant display. When the power is on, all sockets are in power monitoring state. When the sockets are in use, usage of the sockets can be identified in real time, and the maximum power that the sockets can withstand and the real-time power usage can be intuitively seen. The indicator lights adopt energy bar design of different sizes, which can reduce the learning cost of users. More importantly, the present invention makes the sockets safer to use and avoids the occurrence of overload at the first time.

### BRIEF DESCRIPTION OF THE DRAWINGS

FIG. 1 is a three-dimensional structural diagram of a power strip with visual power monitoring proposed by the present invention.

FIG. 2 is a structural diagram of the power strip with visual power monitoring proposed by the present invention from another angle.

FIG. 3 is a schematic diagram of working process of the power strip with visual power monitoring proposed by the present invention.

The markups in the drawings are indicated as follows:
1—bus;
2—spliter;
3—socket; and
4—indicating member.

### SPECIFIC EMBODIMENTS

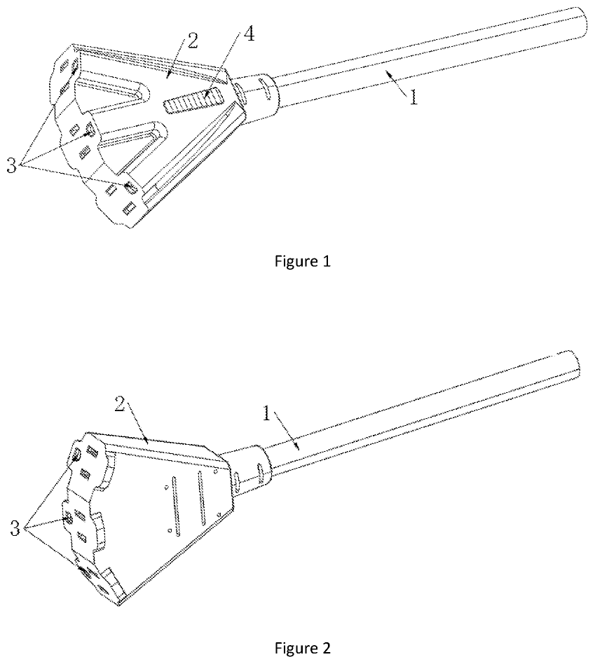

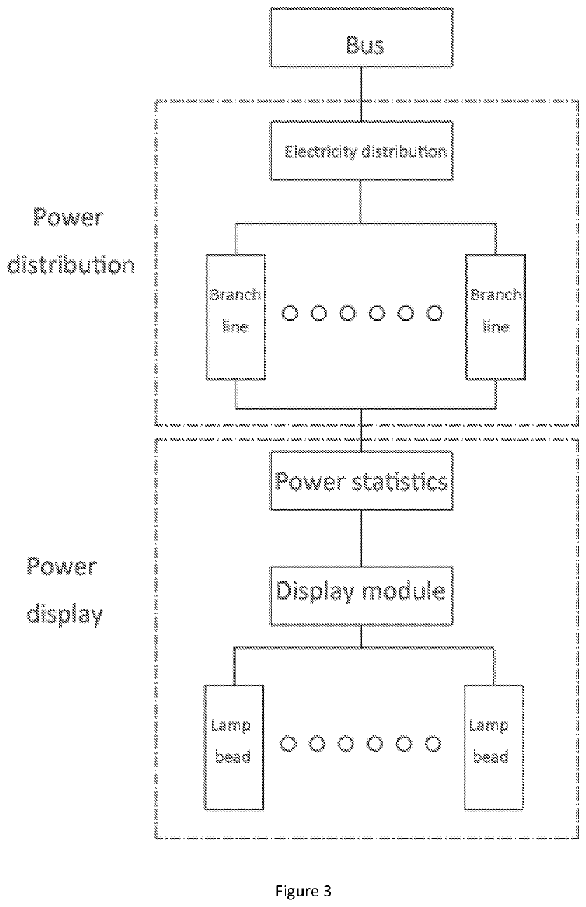

Embodiment 1 as shown in FIGS. 1-3, a power strip with visual power monitoring comprises a power strip with visual power monitoring, comprising a splitter 2, wherein, the power strip with visual power monitoring further comprises: sockets 3, wherein the sockets 3 are provided on the splitter 2; a bus 1, wherein the bus 1 is electrically connected to the sockets 3 through the splitter 2, and the bus 1 is connected to mains electricity; a power statistics module, wherein the power statistics module is provided inside the splitter 2, wherein the power statistics module records power of the sockets 3; an indicating member 4, wherein the indicating member 4 is provided on the splitter 2, and the power statistics module displays the power loaded by the sockets 3 through the indicating member 4. The bus 1 transfers the mains electricity to the sockets 3 through a power distribution module inside the splitter 2, wherein the power distribution module comprises branch lines electrically connected to the sockets 3 with end portions thereof electrically connected to the bus 1. The power statistics module respectively counts power on the branch lines and then summarizes into an internal adder, calculates results through the internal adder, calculates a ratio of calculated results to a set rated power, and lights up the indicating member according to calculated ratio. The indicating member comprises a plurality of grids of LED lights, and load power thereof from zero to a rated load corresponds to a zero grid to a full grid respectively. Color of the LED lights gradually changes from green to red from a zero grid position to a full grid position. Lamp beads are arranged on the splitter 2, and the lamp beads emit light when the splitter 2 is powered on.

Working principle: the present invention comprises safety sockets 3 with real-time power monitoring technology and instant display. When the power is on, all sockets are in power monitoring state. When the sockets are in use, usage of the sockets can be identified in real time, and the maximum power that the sockets can withstand and the real-time power usage of the sockets 3 can be intuitively seen. The indicator lights adopt energy bar design of different sizes, which can reduce the learning cost of users. More importantly, the present invention makes the sockets safer to use and avoids the occurrence of overload at the first time.

The above is only a preferred embodiment of the present invention, and is not intended to limit the present invention in other forms. Any technician familiar with the profession may use the above disclosed technical content to change or modify it into an equivalent embodiment with equivalent changes and apply it to other fields. However, any simple modification, equivalent change and modification made to the above embodiment based on the technical essence of the present invention without departing from the technical solution of the present invention still belongs to the protection scope of the technical solution of the present invention. In the description of the present invention, it should be noted that, unless otherwise clearly specified and limited, the terms “installation”, “connection” and “connection” should be understood in a broad sense, for example, it can be a fixed connection, a detachable connection, or an integral connection; it can be a mechanical connection or an electrical connection; it can be a direct connection, or it can be indirectly connected through an intermediate medium, or it can be the internal connection of two components. For ordinary technicians in this field, the specific meanings of the above terms in the present invention can be understood according to specific circumstances.

1. A power strip with visual power monitoring, comprising a splitter (2), wherein, the power strip with visual power monitoring further comprises: sockets (3), wherein the sockets (3) are provided on the splitter (2);
a bus (1), wherein the bus (1) is electrically connected to the sockets (3) through the splitter (2), and the bus (1) is connected to mains electricity;
a power statistics module, wherein the power statistics module is provided inside the splitter (2), wherein the power statistics module records power of the sockets (3);
an indicating member (4), wherein the indicating member (4) is provided on the splitter (2), and the power statistics module displays the power loaded by the sockets (3) through the indicating member (4).

2. The power strip with visual power monitoring according to claim 1, wherein the bus (1) transfers the mains electricity to the sockets (3) through a power distribution module inside the splitter (2), wherein the power distribution module comprises branch lines electrically connected to the sockets (3) with end portions thereof electrically connected to the bus (1).

3. The power strip with visual power monitoring according to claim 2, wherein the power statistics module respectively counts power on the branch lines and then summarizes into an internal adder, calculates results through the internal adder, calculates a ratio of calculated results to a set rated power, and lights up the indicating member (4) according to calculated ratio.

4. The power strip with visual power monitoring according to claim 3, wherein the indicating member (4) comprises a plurality of grids of LED lights, and load power thereof from zero to a rated load corresponds to a zero grid to a full grid respectively.

5. The power strip with visual power monitoring according to claim 4, wherein color of the LED lights gradually changes from green to red from a zero grid position to a full grid position.

6. The power strip with visual power monitoring according to claim 1, wherein lamp beads are arranged on the splitter (2), and the lamp beads emit light when the splitter (2) is powered on.
